(19) United States
(12) Patent Application Publication
(10) Pub. No.: US 2009/0303179 A1
(43) Pub. Date: Dec. 10, 2009

(54) Kinetic Interface

(76) Inventors: Daniel J Overholt, Aalborg (DK); Dennis M Adderton, Santa Barbara, CA (US); JoAnn C Kuchera-Morin, Goleta, CA (US)

Correspondence Address: MORRISON ULMAN;NUPAT, LLC, PO BOX 1811, MOUNTAIN VIEW, CA, 94042-1811, US

(21) Appl. No.: 12/482,996

(22) Filed: Jun. 11, 2009

Related U.S. Application Data
(63) Continuation-in-part of application No. 11/235,882, filed on Sep. 26, 2005.
(60) Provisional application No. 61/061,632, filed on Jun. 15, 2008.

(51) Int. Cl. G09G 5/00; H04N 7/18

(52) U.S. Cl. 345/156; 348/61; 348/E07.085

(57) ABSTRACT

A kinetic interface for orientation detection in a video training system is disclosed. The interface includes a balance platform instrumented with inertial motion sensors. The interface engages a participant's sense of balance in training exercises.

### RELATED APPLICATIONS

This application claims priority benefit from U.S. Provisional Patent Application Ser. No. 61/061,632, “Gyroscopic Interface for Orientation Detection in a Video Training System”, filed on Jun. 15, 2008 and incorporated herein by reference.

This application is a continuation-in-part of U.S. patent application Ser. No. 11/235,882, “Video Training System”, filed on Sep. 26, 2005 and incorporated herein by reference.

### TECHNICAL FIELD

The disclosure is generally related to the field of video training systems and systems for video self-observation.

### BACKGROUND

Disciplines such as dance, gymnastics and martial arts focus on gaining understanding and control of movement. Achievement in competitive sporting activities is also strongly dependent upon correct form and requires discipline of movement.

Training one's physical expression is hampered by a lack of instant visual feedback in conventional training routines. Conventional exercises do not permit subjects to observe themselves. Instead a subject must rely on oral feedback from an instructor.

It is difficult to change one's behavior without being able to observe it. Video training systems allow subjects to observe their behavior in real-time and to modify their physical expression. The systems provide continuous visual images of the subjects so that they may make behavioral adjustments on the fly.

In a conventional video training system the interface to a subject is limited. What are needed are systems and methods to provide an intuitive, kinetic interface between a subject and a video training system.

### BRIEF DESCRIPTION OF THE DRAWINGS

FIG. 1 shows a video training system with a kinetic interface.

FIG. 2 illustrates details of a sensor assembly of a kinetic interface.

FIG. 3 illustrates an instrumented balance platform.

FIG. 4 illustrates an orientation cursor.

### DETAILED DESCRIPTION

A kinetic interface combined with a video training system brings one's whole body into an immersive experience. The apparatus serves as a tool for participants to effectively practice discipline of movement with video feedback. Navigation of artificial environments is facilitated in such a manner as to train the participant in physical balance ability. A cursor provides an indication of orientation to the participant. The participant may steer the cursor, but to do so requires stable and subtle, physically challenging, control of the interface.

Thus, interaction with an artificial space is improved and the kinetic expression of the entire body is exercised. Physical therapy benefits include the strengthening of stabilizer muscles. Immersive training provides instant visual feedback to monitor adherence to correct form in training routines. Additionally training routines may be automated according to an algorithm which guides the participant to control the cursor.

Orientation detection is implemented by means of an instrumented balance platform. A participant subject stands on the balance platform and views an image on a video display. The image on the video display may include an orientation cursor. The orientation cursor may serve as an indicator to facilitate navigation of an artificial environment. The subject and platform are located within the field of view of a video camera. The camera data may be combined with the orientation cursor to generate a video representation for the display. Furthermore, the orientation cursor may also include a pictographic representation of the subject generated from the camera data.

A pictographic representation of the subject or a live video image serves to allow the subject self-visualization in a third person perspective. When the subject identifies a self-representation within the display, she forms a mentally connected identity with the image. The subject correlates the three-dimensional space she occupies and the artificial environment that the video image occupies. Video processing enables the apparatus to include artificial aspects in the video image of the real environment or to immerse the real video image in an artificial environment. Through participation, the subject engages the artificial environment and objectifies her own presence within it. Self-objectification, in this respect, enables an immersive awareness for the purpose of improved spatial cognition within the artificial environment.

The kinetic interface serves to detect the motion of the subject and engage the subject's sense of balance in establishing perception of orientation in the artificial environment. As the subject leans the platform by shifting her weight, the kinetic output is encoded in the sensor data. The data is received and decoded by a computer to establish navigation of the artificial environment. Linear translation, angular rotation and accelerations of the subject with respect to the artificial environment can be simulated through integration of the kinetic output.

The orientation cursor represents to the subject her orientation in the artificial environment. An abstract icon could serve this purpose, however, realism in the representation makes the cursor more identifiable. It is preferable that a camera image of the participating subject is incorporated in the orientation cursor. Such data may be stereographic or may be combined with a three-dimensional computer model to generate a realistic view of the subject's orientation.

A single camera produces a two-dimensional representation of the subject when output to a display, just as two cameras allow the viewer to infer three-dimensionality through binocular vision. In either case, the representation includes information about a subject's kinetic state. A kinetic interface increases the potential dimensionality of the representation of the subject's kinetic state by incorporating inertial instrumentation. The expansion of dimensionality creates need for the introduction of the orientation cursor. The cursor is defined as a generalization of self representation. Therefore, the pictographic representation of the subject can either be augmented or replaced by an orientation cursor. Furthermore, video representation of the subject can be reduced to an orientation cursor provided that the subject is able to make a self-identification with the cursor.

The balance platform comprises a standing surface and curved supporting body. The supporting body is approximately hemispherical or some truncated portion of a sphere. Commercially available standing platforms use an inflated rubber ball construction where the ball is truncated to some portion less than a hemisphere. The function of the supporting body is to create controllable instability for the participant. The shape of the supporting body is rounded such that when it is weighted off center it will tend to tip and when the weight is re-centered it is righted within the ability of a subject to control it. An inflatable construction has a comfortable feel.

The platform is designed for standing comfortably and may have a flat circular shape. Alternately, the platform may be shaped to simulate specific sporting equipment such as a surfboard or a skateboard. The platform is instrumented with a sensor assembly capable of measuring three rotational degrees of freedom. Signals from each sensor are digitized by the assembly and transmitted by wireless serial link to the processing computer. Preferably, the sensor assembly includes six individual inertial motion sensors fabricated by micromachining techniques and three magnetometers. Three orthogonal accelerometers acquire the orientation of the platform with respect to gravity. Three rotational inertial devices acquire angular acceleration of the platform.

Magnetometers are incorporated in the sensor assembly with the inertial motion sensors on the platform in order to determine orientation with respect to the Earth's magnetic field. The magnetometer data may then be transmitted by serial wireless link in conjunction with the inertial data to the processing computer. By means of one of these sensors, the processing computer is provided an orientation dataset sufficiently complete to ascertain the orientation of the balance platform rapidly and accurately.

The sensor assembly is preferably mounted in the radial center of the balance platform just below the standing surface. Constructed with micro-machined silicon inertial-motion sensors, the assembly may be battery powered and the data may be transmitted by a conventional serial wireless link. Alternatively, a wired link may be used for increased data rates and continuous power.

Sensor data may be decoded before or after transmission. Bandwidth limitations may make it advantageous to decode the sensor data at the platform as transmission of a single orientation vector is more efficient than the raw sensor data. However, the computation required to determine the orientation vector from the sensor data may be more efficient to implement in the processing computer after receiving the transmission of raw sensor data.

Handheld controls may be used for additional navigational parameters. For example, in a three-dimensional data field, the platform orientation may be employed to navigate forward, reverse, left and right, while a handheld remote may navigate up and down. If two-dimensional surfaces are constructed from the higher dimensional data, the platform orientation may be used to navigate on the surface while the handheld control may vary an additional parameter that adjusts the formation of the surface.

The display may employ mechanisms for three-dimensional representation such as stereography. The display may be a wireless head-mounted display. Stereographic representation may require stereo video cameras to image the subject. Additionally, multiple cameras may be used to image the subject from various angles. Video processing may be employed to multiplex between multiple video cameras. Continued improvements in computerized video processing make it feasible to construct a singular three-dimensional model of the subject from video data sourced by multiple cameras disposed with appropriate fields of view. The three-dimensional model of the subject as constructed by the video processing computer is combined with the orientation data to place the pictographic representation of the subject within the artificial environment to facilitate spatial cognition and navigation.

The artificial environment may incorporate remotely located participants or computer generated characters. Camera data may be processed to separate the subject from the background image, such that the subject's image may be displayed within an artificial environment. Furthermore, as an alternative to inertial sensors, optical methods may be substituted for determining the orientation of the platform. One or more optical beacons mounted to the platform are detected by a camera such that the orientation of the platform may be decoded from the camera data by the processing computer. Alternatively, a camera may be mounted to the balance platform and optical beacons within the environment may be detected and decoded at the platform such that an absolute orientation signal may be transmitted by the platform to the processing computer.

The processor may select to mirror the camera image or not mirror the image based on the orientation of the subject as determined by the detection of an orientation beacon or by a pattern recognition algorithm. The correct mirroring of the pictographic representation depends on the geometric mapping of the subject's orientation in the real three-dimensional environment to the navigational coordinates and orientation of the artificial environment.

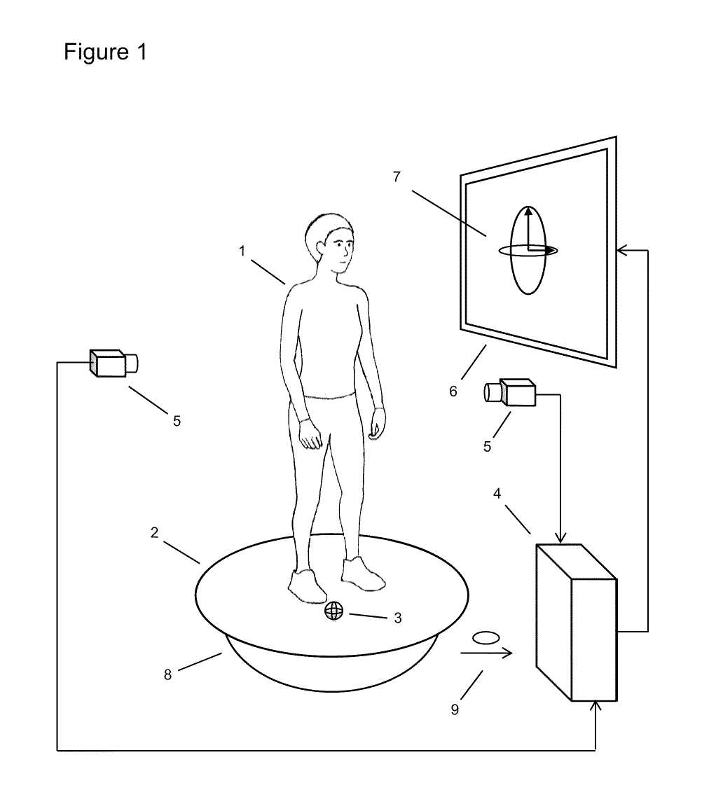

Turning now to the drawings, FIG. 1 shows a video training system with a kinetic interface. Subject (1) stands on balance platform (2) in a manner so as to control the orientation of the platform by shifting her weight with respect to the center of the platform. Balance platform (2) is instrumented with sensor assembly (3) which detects the orientation of the balance platform (2) and transmits the orientation data to a computer (4) by wireless data link (9). Sensor assembly (3) is preferably constructed with micro-machined inertial motion sensors and magnetometers.

Subject (1) is located within the field of view of one or more video cameras (5) and in a position to view video display (6). The output of video camera (5) is processed by computer (4) in conjunction with data from sensor assembly (3) and, computer (4) outputs a video image to display (6) for viewing by subject (1). The video image on display (6) includes a cursor (7) which indicates orientation of the balance platform with respect to the physical space, or, orientation of the physical space with respect to some artificial space. Cursor (7) may include a pictographic representation of subject (1). Balance platform (2) is supported by an inflatable support (8), inflated by some gaseous or viscous substance.

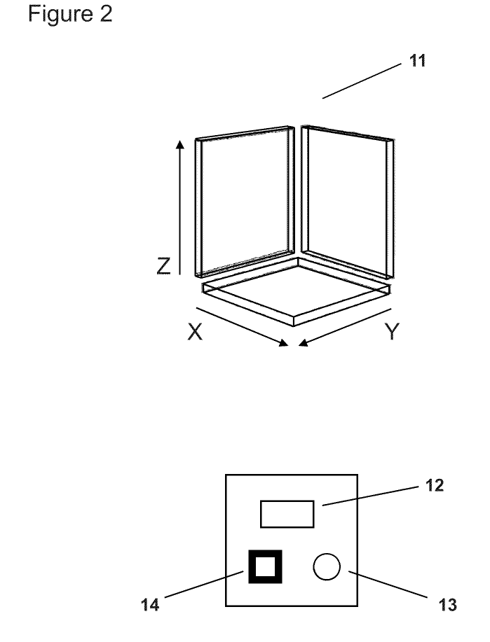

FIG. 2 illustrates details of a sensor assembly of a kinetic interface. Sensor assembly (11) may be constructed from three orthogonal rigid members, such as printed circuit boards. The orthogonal rigid members provide a substrate for orienting sensors along three Cartesian axes, X, Y, and Z. A combination of three sensor types makes it possible to reconstruct an orientation vector with respect to the Earth's gravity and magnetic field. Each Cartesian axis of sensor assembly (11) may include a linear acceleration sensor (12), a rotational acceleration sensor (13), and/or a magnetometer (14). The sensor assembly (11) may include each type of sensor for each axis in order to obtain optimal performance, or may use some combination of fewer sensors to achieve a data quality that is satisfactory for the experience.

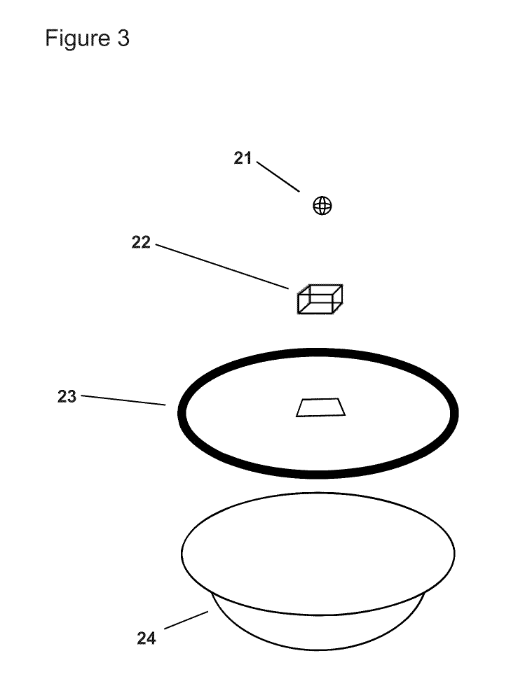

FIG. 3 illustrates an instrumented balance platform. Balance platform (2) of FIG. 1 is shown in FIG. 3 in expanded form to illustrate the assembly of its components. The inertial motion sensor assembly (21) is preferably mounted in the radial center of the platform just below the standing surface (23). Typically, attachment of the sensor assembly (21) to the balance platform is facilitated by mounting the sensor assembly (21) in an electronics enclosure (22) and embedding electronics enclosure (22) in standing platform (23). Standing platform (23) is attached to inflatable support (24). The inflatable support (24) is preferably a dome shaped rubber bladder capable of containing pressurized air under load. Alternatively, the bladder may contain a viscous fluid or may be constructed of a deformable material, such as silicone.

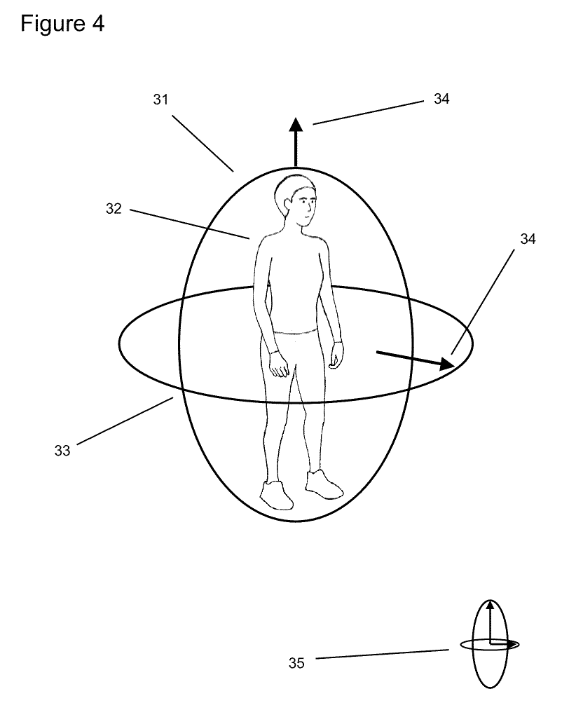

FIG. 4 illustrates an orientation cursor. Orientation cursor (31) may contain a pictographic representation (32) of the subject which indicates orientation data. The orientation cursor (31) may also include a geometric figure (33) which can be used in conjunction with orientation indicators (34) to represent either the orientation of the balance platform with respect to the physical environment or to represent the subject's orientation with respect to an artificial environment. In the case that it is impractical to use a pictographic representation as a cursor, a simplified cursor (35) may be substituted.

As one skilled in the art will readily appreciate from the disclosure of the embodiments herein, processes, machines, manufacture, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, means, methods, or steps.

The above description of illustrated embodiments of the systems and methods is not intended to be exhaustive or to limit the systems and methods to the precise form disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

In general, in the following claims, the terms used should not be construed to limit the systems and methods to the specific embodiments disclosed in the specification and the claims, but should be construed to include all systems that operate under the claims. Accordingly, the systems and methods are not limited by the disclosure, but instead the scope of the systems and methods are to be determined entirely by the claims.

What is claimed is:

1. An apparatus comprising:
a balance platform suitable for supporting a human subject, the platform having a first inertial sensor that senses spatial orientation of the platform and sends the orientation to a computer; and,
a video display that displays to a subject an image rendered by the computer, the image comprising a visual representation of the orientation.

2. The apparatus of claim 1 wherein the inertial sensor is fabricated by micromachining techniques.

3. The apparatus of claim 1 further comprising: an inflatable bladder that supports the platform.

4. The apparatus of claim 1 further comprising: a video camera configured to capture video of the subject on the platform, wherein the computer combines the video with the visual representation of the orientation.

5. The apparatus of claim 1 further comprising:
a second inertial sensor that senses rotations of the platform and sends rotation information to the computer; and,
wherein, the image comprises a visual representation of the rotation information.

6. The apparatus of claim 5 wherein the second inertial sensor is fabricated by micromachining techniques.

7. The apparatus of claim 1 further comprising a magnetometer that senses the orientation of the platform with respect to the Earth's magnetic field.

8. A method for training a subject comprising:
positioning a subject on a balance platform;
detecting the orientation of the balance platform using an inertial motion sensor; and,
representing the orientation on a display visible to the subject.

9. The method of claim 8 wherein the balance platform is supported by an inflatable bladder.

10. The method of claim 8 wherein the subject is positioned within the field of view of a video camera that captures video that is shown on the display.

11. The method of claim 8 further comprising:
detecting rotation of the balance platform using a second inertial motion sensor; and,
representing the rotation on the display.
